(19) United States
(12) Patent Application Publication
(10) Pub. No.: US 2025/0140237 A1
(43) Pub. Date: May 1, 2025

(54) GENERATING BALANCED DATA SETS FOR SPEECH-BASED DISCRIMINATIVE TASKS

(71) Applicant: Cypress Semiconductor Corporation, San Jose, CA (US)

(72) Inventors: Aidan Smyth, Irvine, CA (US); Ashutosh PANDEY, Irvine, CA (US); Yue YIN, Irvine, CA (US); Ted WADA, Irvine, CA (US)

(73) Assignee: Cypress Semiconductor Corporation, San Jose, CA (US)

(21) Appl. No.: 18/499,953

(22) Filed: Nov. 1, 2023

(51) Int. Cl. G10L 15/06; G10L 13/033; G10L 15/02

(52) U.S. Cl. CPC G10L 15/063; G10L 13/033; G10L 15/02; G10L 2015/025

(57) ABSTRACT

Methods and systems for generating balanced data sets for speech-based discriminative tasks. The disclosed method includes, among other things, generating, based on a plurality of natural speech recordings, a synthetic speech data set, modifying, based on language science resources, the synthetic speech data set, and generating, based on the modified synthetic speech data set and the plurality of natural speech recordings, a balanced data set for training a discriminative model to perform a speech-based discriminative task.

### TECHNICAL FIELD

Aspects and implementations of the present disclosure relate to generating balanced data sets for speech-based discriminative tasks.

### BACKGROUND

Speech-based discriminative tasks have gained immense traction in machine learning, revolutionizing how we interact with technology and offering a multitude of applications, ranging from voice-activated assistants to automated customer service solutions and healthcare diagnostics.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example speech-based discriminative task platform, in accordance with implementations of the present disclosure.

FIG. 3 illustrates an example task filter of the speech-based discriminative task platform, in accordance with implementations of the present disclosure.

FIG. 4 illustrates an example augmentation analysis filter of the speech-based discriminative task platform, in accordance with implementations of the present disclosure.

FIG. 5 illustrates an example quality control filter of the speech-based discriminative task platform, in accordance with implementations of the present disclosure.

FIG. 6 illustrates an example distribution manager of the speech-based discriminative task platform, in accordance with implementations of the present disclosure.

FIG. 7 illustrates an example test framework of the speech-based discriminative task platform, in accordance with implementations of the present disclosure.

FIG. 8 depicts a flow diagram of an example method for generating balanced data sets for speech-based discriminative tasks, in accordance with implementations of the present disclosure.

FIG. 9 depicts a flow diagram of an example method for generating balanced data sets for speech-based discriminative tasks, in accordance with implementations of the present disclosure.

FIG. 10 depicts a flow diagram of an example method for generating balanced data sets for speech-based discriminative tasks, in accordance with implementations of the present disclosure.

FIG. 11 is a block diagram illustrating an exemplary computer system, in accordance with implementations of the present disclosure.

### DETAILED DESCRIPTION

Aspects of the present disclosure relate to generating balanced data sets for speech-based discriminative tasks. Speech-based discriminative tasks include keyword spotting, wake word detection, phoneme spotting, emotion detection, transcription, natural language processing (NLP), automatic speech recognition (ASR), etc. Implementing speech-based discriminative tasks involves several stages, from data collection and preprocessing to model training and deployment.

Traditionally, data collection may be further divided into additional steps involving dataset procurement and data augmentation. Labeled speech data relevant to a specified speech-based discriminative task (e.g., wake word detection) is obtained during dataset procurement. However, dataset procurement requires internal and/or third-party data engineers (collectively, data engineers) using defined goals and specific requirements to scrape and, in some instances, purchase large volumes of natural data that satisfies the defined objectives and specialized requirements of the specified speech-based discriminative task. As a result, dataset procurement is often time-consuming and costly and can involve various ethical and legal considerations. Additionally, suppose there are alterations to the existing speech-based discriminative task or the introduction of a novel speech-based discriminative task. In that case, data engineers must restart the entire data procurement process. This is due to the consequent shifts in defined objectives and specialized requirements, necessitating new, relevant natural data acquisition.

Cutting-edge developments in text-to-speech (TTS) technologies (or engines) equip data engineers to generate large volumes of highly naturalistic, synthetic speech across different languages, accents, and emotional tones. TTS enables data engineers to perform dataset procurement tailored to a specified speech-based discriminative task, bypassing the need for large volumes of natural data. While TTS can generate increasingly naturalistic synthetic speech, the data often differ in distribution from natural speech, affecting nuances like emotion and pitch. These differences can significantly impact a model's performance in speech-based discriminative tasks. Models trained solely on synthetic speech may struggle to generalize to natural scenarios. Therefore, accounting for these distributional differences is crucial by shifting the synthetic distribution closer to the natural distribution.

Aspects and embodiments of the present disclosure address these and other limitations of the existing technology by enabling systems and methods of generating balanced data sets for speech-based discriminative tasks. More specifically, identifying a set of speakers and a set of speech characteristics based on a speech-based discriminative task to generate synthetic speech. Each speaker of the set of speakers refers to a natural speech recording. Multiple synthetic speech is generated based on the set of speakers and the set of speech characteristics parameters. Each generated synthetic speech recording of the multiple synthetic speech is assessed to determine how closely it resembles an expected natural representation. One or more augmentation techniques and a defined order of the one or more augmentation techniques are determined based on the generated synthetic speech's closeness to the expected natural representation to augment the generation synthetic speech. Each synthetic speech recording of the multiple synthetic speech is augmented based on the ordered one or more augmentation techniques associated with a respective synthetic speech recording of the multiple synthetic speech.

Each synthetic speech recording of the multiple synthetic speech is further assessed to determine whether a transcript associated with a respective synthetic speech matches the audio associated with the respective synthetic speech. Each synthetic speech recording of the multiple synthetic speech in which the transcript associated with a respective synthetic speech does not match the audio associated with the respective synthetic speech is removed. Synthetic speech recordings of the multiple synthetic speech and natural speech are sampled according to a distribution configuration associated with the speech-based discriminative task to generate a balanced data set. The balanced data set is used to train a machine learning (ML) model to perform the speech-based discriminative task. Multiple test data may be obtained from different points while generating the balanced data set. The multiple test data may be used to test the trained ML model and generate a report based on the results of the multiple test data. The report is used to adjust how subsequent synthetic speech used to train subsequent ML models is generated, augmented, and/or flagged.

Aspects of the present disclosure overcome these deficiencies and others by producing more natural, synthetic speech for a specific speech-based discriminative task to create a balanced data set for training, thereby reducing the necessity for dataset procurement.

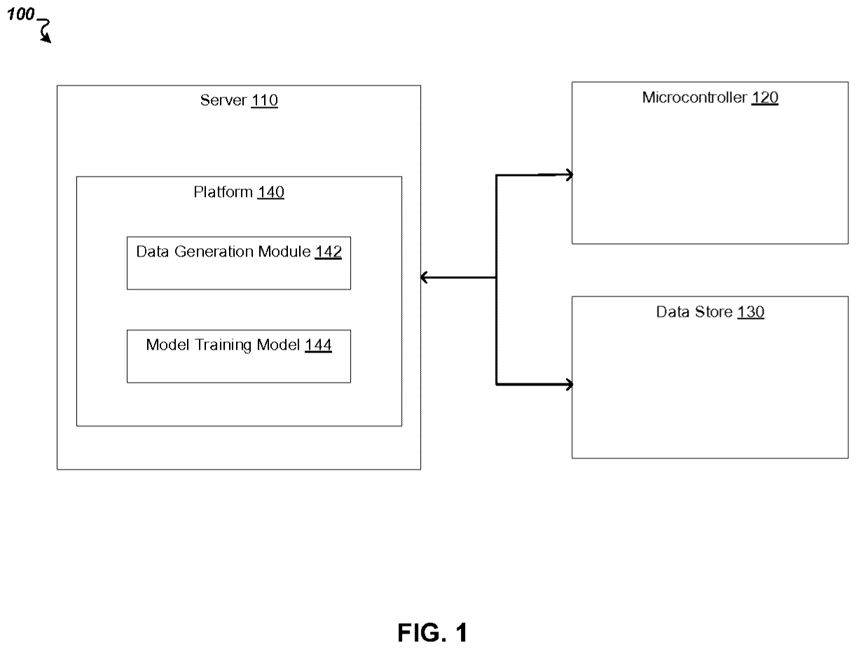

FIG. 1 illustrates an example system architecture 100, in accordance with implementations of the present disclosure. System architecture 100 (also referred to as “system” herein) includes a server 110 (also referred to as “server” herein) and a microcontroller 120 that are communicatively coupled to each other. System 100 also includes a data store 130 communicatively coupled to server 110. Server 110 may be a computing device (e.g., a desktop computer, a laptop computer, a mainframe computer, a server computer, etc.).

In some implementations, data store 130 is a persistent storage capable of storing trained neural networks. Data store 130 can be hosted by one or more storage devices, such as main memory, magnetic or optical storage-based disks, tapes or hard drives, NAS, SAN, and so forth. In some implementations, data store 130 can be a network-attached file server, while in other embodiments, data store 130 can be some other type of persistent storage such as an object-oriented database, a relational database, and so forth, that may be hosted by server 110 via the network.

Data store 130 may include a task-to-speaker data structure, a natural speech database, a phonemes data structure (or phonemes library), an acoustic model, and a linguistic data structure (or linguistic library).

A task-to-speaker data structure may include a plurality of entries in which each entry maps a speech-based discriminative task to a set of speech characteristics. Speech characteristics refer to various elements that contribute to the unique qualities of human speech and voice (e.g., a speaker). Speech characteristics can include, for example, prosody, duration, emotion, pitch, pace, emphasis, accents, languages, etc. Each speech characteristic of the set of speech characteristics is defined using a numerical range.

A natural speech database may include a plurality of synthetic speech recordings in which each natural speech recording is an audio recording or transcription of a speaker captured in natural, uncontrolled environments. The plurality of synthetic speech recordings varies in accents and dialects, emotional nuances, background noise, speech disfluencies, speakers (e.g., male or female), recording quality, jargon, multilingual speech, etc. Each natural speech recording contains metadata that provides the speech characteristics of the natural speech recording in which each speech characteristic is defined using a numerical value.

A phonemes data structure may includes a plurality of entries, in which each entry maps a word or phrase to a sequence of phoneme symbols that represent how the text should be pronounced.

An acoustic model is a model (statistical or deep learning model) that converts written text into speech based on a relationship between audio signals and the phonemes or other linguistic units that make up a specified text.

Server 110 includes a speech-based discriminative task platform (or platform 140). Platform 140 includes a data generation module 142 and a model training module 144.

Data generation module 142 may receive a speech-based discriminative task. In some embodiments, a user, such as a data engineer, may input into the data generation module 142 the speech-based discriminative task (e.g., keyword spotting, wake word detection, phoneme spotting, emotion detection, transcription, natural language processing (NLP), automatic speech recognition (ASR), etc.) Responsive to receiving the speech-based discriminative task, data generation module 142 may query the task-to-speaker data structure for a set of speech characteristics associated with the speech-based discriminative task. Data generation module 142 generates, based on the set of speech characteristics, a natural data set that includes one or more natural speech recordings.

In some embodiments, data generation module 142 generates the natural data set by determining, for each natural speech recording of the natural speech database, whether a numerical value of each of the speech characteristics of a respective natural speech recording falls within a numerical range of a corresponding speech characteristic of the set of speech characteristics. Each natural speech recording in which the numerical values of all the speech characteristics fall within the numerical ranges of the set of speech characteristics is included in the natural data set. In some embodiments, data generation module 142 may utilize a natural speech database filtering functionality to query and retrieve all natural speech recordings that satisfy the set of speech characteristics, thereby excluding the natural speech recordings that do not satisfy the set of speech characteristics.

Data generation module 142 provides the natural data set and the set of speech characteristics to a TTS engine (similar to the TTS described above), which interprets each natural speech recording of the natural data set as a speaker to be cloned. TTS engine generates a plurality of synthetic speech recordings. Each synthetic speech recording of the plurality of synthetic speech recordings corresponds to a synthetic speech recording generated for a specified text of a plurality of specified text in a voice that resembles each speaker's voice of the natural data set. The specified text may be positive text, which refers to text associated with a wake word used in wake word detection, or negative text, which refers to text not associated with the wake word used in wake word detection. Accordingly, generated synthetic speech recordings for positive specified text are referred to as positive synthetic speech recordings, and generated synthetic speech recordings for negative specified text are referred to as negative synthetic speech recordings.

TTS engine may further utilize the set of speech characteristics to fine-tune and improve the accuracy and naturalness of the plurality of synthetic speech recordings. The positive synthetic speech recordings of the plurality of synthetic speech may be combined into a synthetic positive data set) and the negative synthetic speech recordings of the plurality of synthetic speech may be combined into a synthetic negative data set. In some embodiments, the synthetic positive data set and/or the synthetic negative data set may be stored in the data store 130.

Data generation module 142 may obtain expected speech characteristics for each synthetic speech recording of the synthetic positive data set and the synthetic negative data set (collectively, synthetic data set). In particular, for each synthetic speech recording of the synthetic data set, data generation module 142 obtains specified text contained in metadata of a respective synthetic speech recording used to generate the respective synthetic speech recording. Data generation module 142 queries, using the specified text of a respective synthetic speech recording, the phonemes data structure to retrieve a sequence of phoneme symbols associated with the specified text of the respective synthetic speech recording. Using the acoustic model, data generation module 142 generates the appropriate acoustic signals for each phoneme in the sequence of phoneme symbols to produce an expected audio output associated with the specified text of the respective synthetic speech recording.

In some embodiments, the expected audio output contains metadata indicating the speech characteristics of the expected audio output (e.g., the expected speech characteristics). Data generation module 142 obtains expected speech characteristics contained in the metadata of the expected audio output associated with the respective synthetic speech recording. Data generation module 142 identifies differences between the expected speech characteristics of the expected audio output associated with the respective synthetic speech recording and the speech characteristics of the respective synthetic speech recording (e.g., actual speech characteristics).

Data generation module 142, based on the differences, determines one or more augmentation techniques that, when applied in a specific order (e.g., a series of chained augmentation techniques), minimize (or eliminate) the differences of the respective synthetic speech recordings so they match. Augmentation techniques may include, for example, time stretching, pitch shifting, noise injection, reverberation, equalization, time shifting, volume adjustment, speed and tempo changes, random cropping, resampling, etc.

Data generation module 142 stores the series of chained augmentation techniques associated with the respective synthetic speech recordings in the metadata of the respective synthetic speech recordings. Accordingly, the metadata of each synthetic speech recording of the synthetic positive data set and the synthetic negative data set is updated by the data generation module 142, thereby generating an updated synthetic positive data set and an updated synthetic negative data set, respectively. In some embodiments, the updated synthetic positive data set and/or the updated synthetic negative data set may be stored in data store 130.

Data generation module 142 provides the updated synthetic positive data set and the updated synthetic negative data set to a data augmentation engine. Data augmentation engine, for each synthetic speech recording (of the updated synthetic positive data set and the updated synthetic negative data set), retrieves the series of chained augmentation techniques from the metadata of a respective synthetic speech recording and performs each augmentation technique of the series of chained augmentation techniques in the defined order on the respective synthetic speech recording to generate an augmented synthetic speech recording. Accordingly, each synthetic speech recording of the updated synthetic positive data set may be augmented to generate an augmented synthetic positive data set, and each synthetic speech recording of the updated synthetic negative data set may be augmented to generate an augmented synthetic negative data set. In some embodiments, the augmented synthetic positive data set and/or augmented synthetic negative data set may be stored in data store 130.

Data generation module 142, for each synthetic speech recording of the augmented synthetic data set (of the augmented synthetic positive data set and augmented synthetic negative data set), attempts to generate a time-aligned annotation for a respective synthetic speech recording in view of a specified speech associated with the synthetic speech recording. If the data generation module 142 fails to generate the time-aligned annotation for the respective synthetic speech recording, data generation module 142 flags the respective synthetic speech recording for removal. Data generation module 142, for each synthetic speech recording of the augmented synthetic data set, may assess different aspects of the audio quality (e.g., clipping, expected duration, signal-to-noise ratio (SNR)) of a respective synthetic speech recording using the linguistic library and/or acoustic model. If data generation module 142 determines that an aspect of the audio quality is not satisfied, data generation module 142 flags the respective synthetic speech recording for removal. Accordingly, data generation module 142 removes any synthetic speech recording of the augmented synthetic positive data set to generate a quality synthetic positive data set and any synthetic speech recording of the augmented synthetic negative data set to generate a quality synthetic negative data set. In some embodiments, the quality synthetic positive data set and quality synthetic negative data set may be stored in data store 130.

Data generation module 142 may generate, from the natural speech database, a natural positive data set including one or more natural speech recordings associated with positive specified speech and a natural negative data set including one or more natural speech recordings associated with negative specified speech. In some embodiments, the natural speech database may not include any natural speech recordings associated with positive specified speech. Accordingly, the data generation module 142 will not generate the natural positive data set. In some embodiments, the natural positive data set and/or natural negative data set may be stored in data store 130.

Data generation module 142 may identify, based on the speech-based discriminative task, a distribution configuration used to dictate the sampling of a plurality of data sets (e.g., the quality synthetic positive data set, the quality synthetic negative data set, the natural positive data set, and natural negative data set) to generate a balanced data set.

In some embodiments, data store 130 may include a task-to-distribution configuration data structure that maps each speech-based discriminative task to a corresponding distribution configuration. Thus, the data generation module 142 queries the task-to-distribution configuration data structure to identify the distribution configuration to apply. The distribution configuration defines how sampling is applied to one or more data sets to achieve an appropriate ratio of types (e.g., positive to negative, synthetic to natural, male to female, native to non-native speakers, present augmentations, etc.). Data generation module 142 may sample (or select) one or more speech recordings from the plurality of data sets that comply with the appropriate ratios defined in the distribution configuration to generate a balanced data set. For example, a first subset of the balanced data set may include one or more speech recordings from the quality synthetic positive data set and/or the quality synthetic negative data set. As previously described, the quality synthetic positive data set and/or the quality synthetic negative data set is a subset of the augmented synthetic speech data set. A second subset of the balanced data set may include one or more speech recordings from the natural positive data set and/or natural negative data set. Accordingly, the first and second subset of the balanced data set may be combined to generate the balanced data set.

Data generation module 142 may provide, to the model training module 144, the balanced data set to train a machine learning (ML) model designed to perform the speech-based discriminative task. Model training module 144 trains the ML model using the balanced data set. Model training module 144 may provide the trained ML model to the data generation module 142.

Data generation module 142 may receive a trained ML model. Data generation module 142 may generate a plurality of test data from a plurality of data sets. The plurality of data sets includes the synthetic positive data set, the synthetic negative data set, the augmented synthetic positive data set, the augmented synthetic negative data set, the quality synthetic positive data set, the quality synthetic negative data set, the natural positive data set, and the natural negative data set. Data generation module 142 selects at least one speech recording from each data set of the plurality of data sets to generate a test data of the plurality of test data and label it according to the source of the speech recording (e.g., synthetic negative based on speech recording selected from the synthetic negative data set).

Data generation module 142 may input each test data of the plurality of test data into the trained ML model. Data generation module 142 may generate a test report that includes the results of each test data inputted into the trained ML model. In particular, each result will be separated and organized in the test report based on the label of the inputted test data. Data generation module 142, based on the test report, assesses the accuracy of the trained ML model and any biases toward specific test data. Accordingly, based on the test report, data generation module 142 may modify how subsequent data sets are generated to prevent any bias.

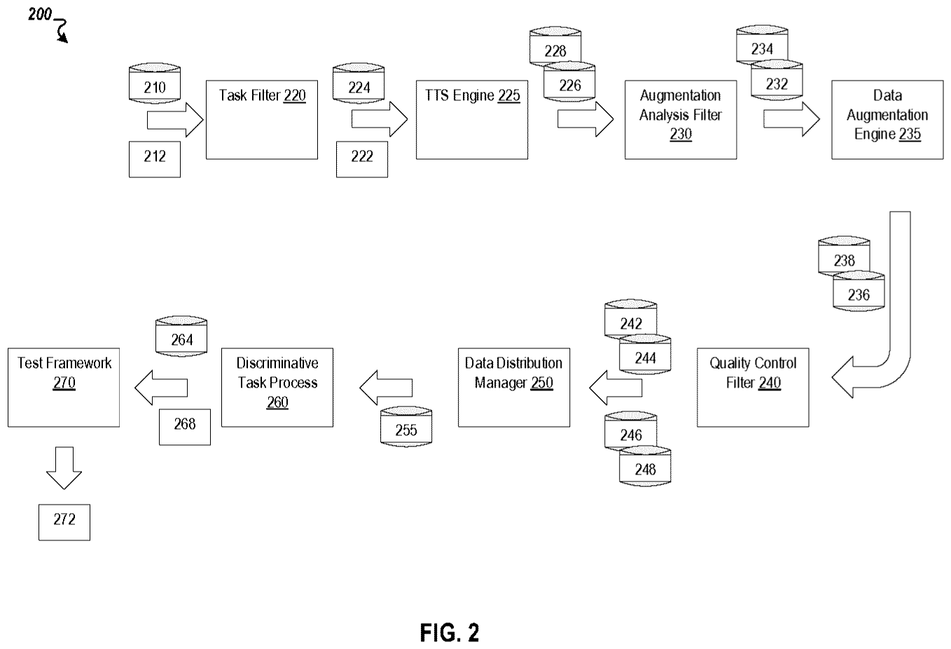

FIG. 2 illustrates an example of speech-based discriminative task platform 210, in accordance with implementations of the present disclosure. Speech-based discriminative task platform 210 includes a task filter 220, a TTS engine 225, an augmentation analysis filter 230, a data augmentation engine 235, a quality control filter 240, a distribution manager 250, a discriminative task process 260, and a test framework 270.

Task filter 220 identifies a natural speech database 210. Task filter 220 receives a speech-based discriminative task 212 that filters down the natural speech database 210 into a natural data set 224. Task filter 220 provides the natural data set 224 and a set of speech characteristics 222 to the TTS engine 225.

TTS engine 225 receives the natural data set 224 and the set of speech characteristics 222. TTS engine 225 interprets each natural speech recording of the natural data set 224 as a speaker to be cloned. TTS engine 225 generates a synthetic positive data set 226 (e.g., synthetic speech recordings associated with a wake word used in wake word detection) and a synthetic negative data set 228 (e.g., synthetic speech recordings not associated with a wake word used in wake word detection) in a voice that resembles the voice of each speaker of the natural data set 224. TTS engine 225 may fine-tune and improve the accuracy and naturalness of the positive and negative synthetic speech recordings using the set of speech characteristics 222 provided by task filter 220. TTS engine 225 provides the synthetic positive data set 226 and the synthetic negative data set 228 to the augmentation analysis filter 230.

Augmentation analysis filter 230 receives the synthetic positive data set 226 and negative data set 228. Augmentation analysis filter 230 identifies one or more augmentation techniques that, when applied in a specific order (e.g., series of chained augmentation techniques), minimize (or reduce, or eliminate) the difference between actual speech characteristics of the synthetic speech recording and expected speech characteristics of the synthetic speech recording, so they match. Augmentation analysis filter 230 updates the metadata of each synthetic speech recording (of the synthetic positive data set 226 and/or the synthetic negative data set 228) with their corresponding series of chained augmentation techniques to generate an updated synthetic positive data set 232 and/or an updated synthetic negative data set 234. Augmentation analysis filter 230 provides the updated synthetic positive data set 232 and the updated synthetic negative data set 234 to the data augmentation engine 235.

Data augmentation engine 235 receives the updated synthetic positive data set 232 and the updated synthetic negative data set 234. Data augmentation engine 235 augments each synthetic speech recording (of the updated synthetic positive data set 232 and the updated synthetic negative data set 234) according to the series of chained augmentation techniques defined in their metadata to generate an augmented synthetic speech data set (e.g., augmented synthetic positive data set 236) and an augmented synthetic speech data set (e.g., augmented synthetic negative data set 238), respectively. Data augmentation engine 235 provides the augmented synthetic positive data set 236 and the augmented synthetic negative data set 238 to the quality control filter 240.

Quality control filter 240 receives the augmented synthetic positive data set 236 and the augmented synthetic negative data set 238. Quality control filter 240 performs, for each synthetic speech recording (of the augmented synthetic positive data set 236 and/or the augmented synthetic negative data set 238), alignment between the actual time-aligned annotation information and the expected time-aligned annotation information. Quality control filter 240 flags and/or removes each synthetic speech recording (of the augmented synthetic positive data set 236 and/or the augmented synthetic negative data set 238) to generate the quality synthetic positive data set 246 and/or the quality synthetic negative data set 248. Quality control filter 240 provides the quality synthetic positive data set 246 and the quality synthetic negative data set 248 to the distribution manager 250.

Distribution manager 250 receives the quality synthetic positive data set 246, the quality synthetic negative data set 248, a natural negative data set 244, and, in some instances, the natural positive data set 242. Distribution manager 250, based on the speech-based discriminative task 212, selects a distribution configuration used to dictate sampling from the various data sets (e.g., the quality synthetic positive data set 246, the quality synthetic negative data set 248, the natural negative data set 244, and/or the natural positive data set 242). Distribution manager 250 samples the various data sets to generate a balanced data set 255. Distribution manager 250 provides the balanced data set 255 to the discriminative task process 260.

Discriminative task process 260 receives the balanced data set 255. Discriminative task process 260 trains a machine learning (ML) model to perform the speech-based discriminative task 212 with the balanced data set 255. Discriminative task process 260 provides a trained ML model 268 to test framework 270.

Test framework 270 receives the trained ML model 268. In addition to the trained ML model 268, test framework 270 receives test data 264 (e.g., speech recordings) from the synthetic positive data set 226, the synthetic negative data set 228, the augmented synthetic positive data set 236, the augmented synthetic negative data set 238, the quality synthetic positive data set 246, the quality synthetic negative data set 248, the natural positive data set 242, and/or the natural negative data set 244. Test framework 270 inputs, one by one, the test data 264 into the trained ML model 268 to generate a test report 272 organized by type of input data. Test framework 270 identifies, based on the test report 272, biases towards any specific type of input data and automatically adjusts the configuration of the task filter 220, the augmentation analysis filter 230, the quality control filter 240, and/or the distribution manager 250 to prevent the bias for subsequent generation of the balanced data set 255 used to train (or retrain) another ML model.

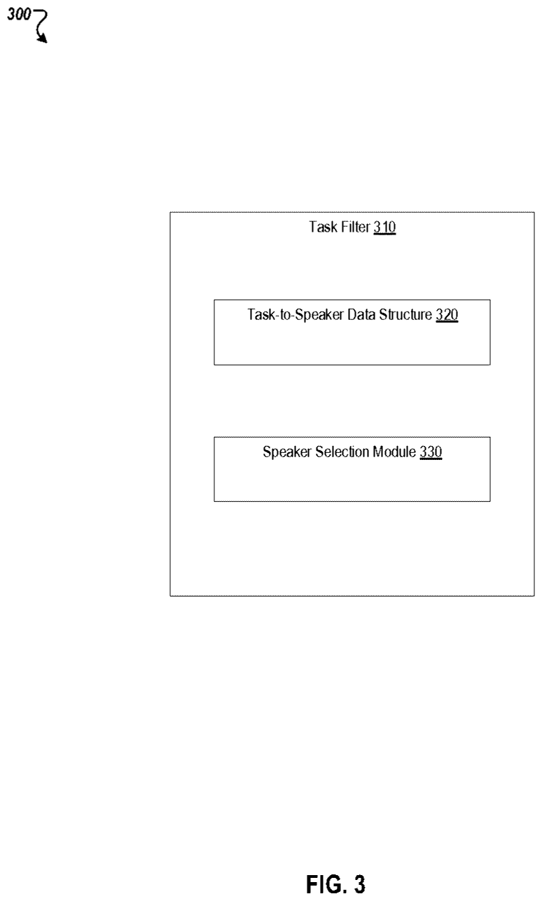

FIG. 3 illustrates an example task filter of the speech-based discriminative task platform, in accordance with implementations of the present disclosure. Task Filter 310 (similar to task filter 220 of FIG. 2) includes a task-to-speaker data structure 320 and a speaker selection module 330.

Task-to-speaker data structure 320 maps each speech-based discriminative task to a set of speech characteristics. The mapping of the speech-based discriminative tasks to sets of speech characteristics may be determined based on ideal speakers that provide the best synthetic speech to train an ML model for the specified speech-based discriminative task. In some embodiments, the task-to-speaker data structure 320 may be apart and/or separate from the task filter 310, for example, stored in a data store (e.g., data store 130 of FIG. 1).

Speech-based discriminative tasks, as noted above, may include keyword spotting, wake word detection, phoneme spotting, emotion detection, transcription, natural language processing (NLP), automatic speech recognition (ASR), etc. The set of speech characteristics defines unique qualities of human speech and voice (e.g., a speaker). Speech characteristics can include, for example, prosody, duration, emotion, pitch, pace, emphasis, accents, languages, etc. Each speech characteristic of the set of speech characteristics is defined using a numerical range.

In some embodiments, a speech-based discriminative task may be inputted in the task filter 310 by a user, such as a data engineer. Speaker selection module 330 may receive the speech-based discriminative task and query the task-to-speaker data structure 320 to identify a set of speech characteristics associated with the speech-based discriminative task. Speaker selection module 330, according to the set of speech characteristics, retrieves from a natural speech database a set of speakers (e.g., multiple natural speech recordings) that satisfy the set of speech characteristics.

The natural speech database comprises multiple natural speech recordings, each containing metadata indicating their speech characteristics. Each speech characteristic contained in the metadata of a natural speech recording is defined using a numerical value. The natural speech database may be stored in a data store accessible by the task filter 310 and its modules. In some embodiments, the natural speech database may be inputted into the task filter 310. In any event, retrieving from the natural speech database includes querying the natural speech database to identify a set of speakers that satisfy the set of speech characteristics and storing the set of speakers into a data set of natural speech (also referred to as natural data set).

In some embodiments, querying the natural speech database to identify a set of speakers that satisfy the set of speech characteristics may include, for each natural speech recording of the natural speech database, determining whether a numerical value associated with each speech characteristic contained in the metadata of a respective natural speech recording falls within a numerical range of a matching speech characteristics of the set of speech characteristics.

In some embodiments, querying the natural speech database to identify a set of speakers that satisfy the set of speech characteristics may include utilizing a filtering functionality of the query and retrieving all natural speech recordings that satisfy the set of speech characteristics, thereby excluding the natural speech recordings that do not satisfy the set of speech characteristics.

In some embodiments, the speaker selection module 330 may provide the natural data set and the set of speech characteristics to a TTS engine (e.g., TTS engine 225 of FIG. 2). In some embodiments, the speaker selection module 330 may store the natural data set and the set of speech characteristics in a data store accessible by the TTS engine. Accordingly, based on the combination of the natural data set and the set of speech characteristics, a TTS engine can generate more accurate and natural synthetic speech resembling ideal speakers for a specific speech-based discriminative task.

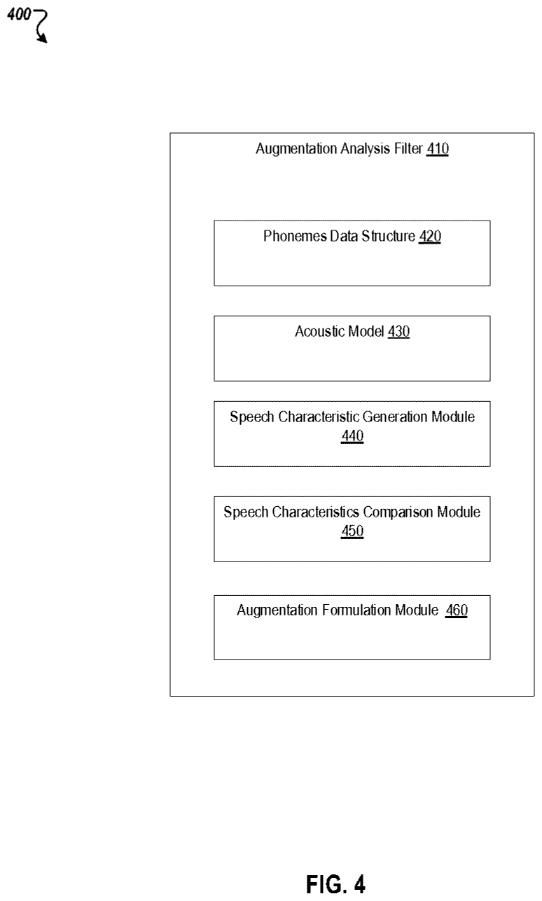

FIG. 4 illustrates an example augmentation analysis filter of the speech-based discriminative task platform, in accordance with implementations of the present disclosure. Augmentation analysis filter 410 (similar to augmentation analysis filter 230 of FIG. 2) includes a phonemes data structure 420, an acoustic model 430, a speech characteristics generation module 440, a speech characteristics comparison module 450, and an augmentation formulation module 460.

Phonemes data structure 420 includes a plurality of entries in which each entry maps a word or phrase to a sequence of phoneme symbols that represent how the text should be pronounced. Acoustic model 430 is a model (e.g., statistical or deep learning model) that converts written text into speech based on a relationship between audio signals and the phonemes or other linguistic units that make up a specified text. In some embodiments, the phonemes data structure 420 and the acoustic model 430 may be apart and/or separate from the augmentation analysis filter 230, for example, stored in a data store (e.g., data store 130 of FIG. 1).

Speech characteristics generation module 440 receives a synthetic positive data set and a synthetic negative data set, which were generated by a TTS engine (e.g., TTS engine 225 of FIG. 2). Synthetic positive data set, as noted above, includes a plurality of synthetic speech recordings associated with a specified text that corresponds to a wake word to be used in wake word detection (e.g., a speech-based discriminative task an ML model will be trained to perform). Synthetic negative data set, as noted above, includes a plurality of synthetic speech recordings associated with a specified text that does not correspond to a wake word to be used in wake word detection (e.g., a speech-based discriminative task an ML model will be trained to perform). Each synthetic speech recording of the synthetic positive data set and synthetic negative data set (collectively referred to as synthetic data set) includes metadata that dictates the specified text used to generate the synthetic speech recording.

Speech characteristics generation module 440, for each synthetic speech recording of the synthetic data set, obtains a specified text contained in the metadata of a respective synthetic speech recording. Speech characteristics generation module 440 queries the phonemes data structure 420 to identify a sequence of phoneme symbols that correspond to the obtained specified text of the respective synthetic speech recording. Speech characteristics generation module 440 causes acoustic model 430 to generate the appropriate acoustic signals for each phoneme in the sequence of phoneme symbols to produce an expected audio output associated with the specified text by synthesizing the generated acoustic signals.

The expected audio output may contain metadata indicating the speech characteristics of the expected audio output (e.g., the expected speech characteristics). Accordingly, the speech characteristics generation module 440 may obtain the expected speech characteristics from the metadata of the expected audio output. In some embodiments, the expected speech characteristics may be stored in the metadata of the respective synthetic speech recording.

Speech characteristics comparison module 450 may receive the expected speech characteristics for each synthetic speech recording of the synthetic data set. Depending on the embodiment, the expected speech characteristics may be received from the metadata of the respective synthetic speech recording or from the speech characteristics generation module 440. In any event, the speech characteristics comparison module 450, for each synthetic speech recording of the synthetic data set, compares the speech characteristics of a respective synthetic speech recording (e.g., actual speech characteristics) with the expected speech characteristics of the respective synthetic speech recording. Based on the comparison, speech characteristics comparison module 450 may identify one or more differences between the actual speech characteristics and the expected speech characteristics of the respective synthetic speech recording (e.g., speech characteristics delta). For example, the speech characteristics delta may indicate a shifted and/or scalar difference in an index of a particular row in the matrix of Mel-frequency cepstral coefficients (MFCCs) or distribution of token duration times between expected natural speech and synthetic speech associated with a specific text.

Augmentation formulation module 460, for each synthetic speech recording of the synthetic data set, determines, based on a speech characteristics delta associated with a respective synthetic speech recording, one or more augmentations techniques that, when applied in a specific order, minimize (or eliminate) the difference between the actual speech characteristics and the expected speech characteristics of the respective synthetic speech recording, so they match. The combination of the determined augmentation techniques and specific order is defined using a series of chained augmentation techniques. Augmentation techniques may include, for example, time stretching, pitch shifting, noise injection, reverberation, equalization, time shifting, volume adjustment, speed and tempo changes, random cropping, resampling, etc.

Accordingly, each series of chained augmentation techniques provides augmentation engines instructions on addressing gaps between expected natural speech and synthetic speech recordings rather than arbitrarily augmenting synthetic speech recordings.

Augmentation formulation module 460 stores the series of chained augmentation techniques associated with the respective synthetic speech recording in the metadata of the respective synthetic speech recording, creating an updated synthetic positive data set and an updated synthetic negative data set.

In some embodiments, the augmentation formulation module 460 may provide the updated synthetic positive data set and the updated synthetic negative data set to an augmentation engine (e.g., augmentation engine 235 of FIG. 2). In some embodiments, the augmentation formulation module 460 may store the updated synthetic positive data set and the updated synthetic negative data set in a data store accessible by the augmentation engine.

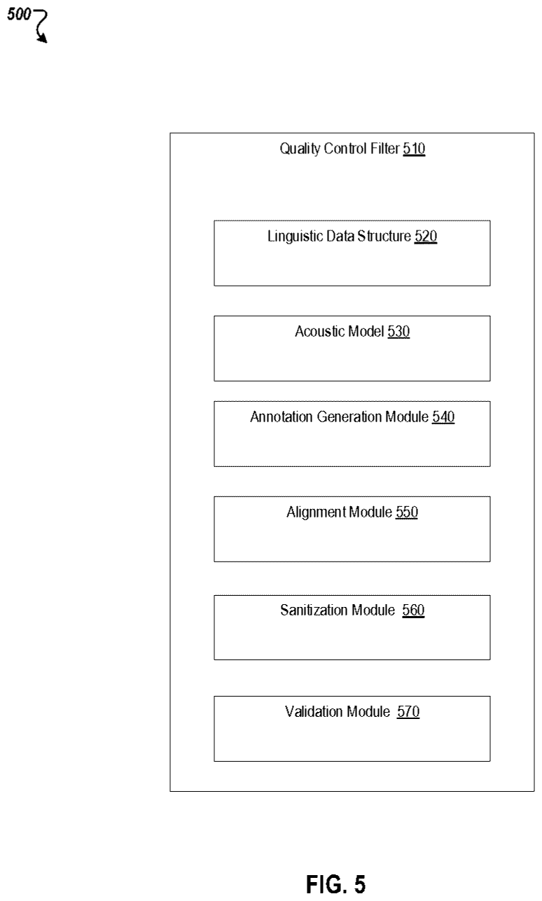

FIG. 5 illustrates an example quality control filter of the speech-based discriminative task platform, in accordance with implementations of the present disclosure. Quality control filter 510 (similar to quality control filter 240 of FIG. 2) includes a linguistic data structure 520, an acoustic model 530, an annotation generation module 540, an alignment module 550, a sanitization module 560, and a validation module 570.

Linguistic data structure 520 includes a plurality of entries in which each entry maps text to phonemes representing how text should be pronounced. Acoustic model 530 (similar to acoustic model 430 of FIG. 4) is a model (statistical or deep learning model) that converts written text into speech based on a relationship between audio signals and the linguistic units that make up a specified text. In some embodiments, the linguistic data structure 520 and the acoustic model 530 may be apart and/or separate from the quality control filter 240, for example, stored in a data store (e.g., data store 130 of FIG. 1). In some embodiments, the acoustic model 530 and the acoustic model 430 of FIG. 4 may be a single acoustic model stored in the data store.

Alignment module 550 may receive an augmented synthetic positive data set and an augmented synthetic negative data set (collectively, the augmented synthetic data set) generated by the augmentation engine (e.g., augmentation engine 235 of FIG. 2).

Alignment module 550, for each synthetic recording of the augmented synthetic data set, utilizing the acoustic model 530, identifies phonemes of a respective synthetic speech recording. Alignment module 550 obtains specified text contained in the metadata of the respective synthetic speech recording. Alignment module 550 determines the phonemes associated with the specified text. Alignment module 550 determines an alignment between the phonemes associated with the specified text and the phonemes of the respective synthetic speech recording. Alignment module 550 determines whether the alignment is successful. If the alignment is successful, alignment module 550 provides the alignment information to the annotation generation module 540. If the alignment is unsuccessful, alignment module 550 flags the respective synthetic speech recording for removal.

Annotation generation module 540 receives the alignment information. Annotation generation module 540 annotates the respective synthetic speech recording based on the alignment information. Annotating the respective synthetic speech recording provides a start time, an end time, and a label associated with the phoneme. In some embodiments, the annotation generation module 540 may fail. If the annotation generation module 540 fails to annotate the respective synthetic speech recording, the annotation generation module 540 flags the respective synthetic speech recording for removal.

Sanitization module 560, for each synthetic speech recording of the augmented synthetic data set, may assess different aspects of the audio quality of a respective synthetic speech recording using the linguistic library and/or acoustic model. Audio quality may include clipping of audio, expected duration of audio, signal-to-noise ratio (SNR) of audio, etc. Sanitization module 560, based on the audio quality in view of the linguistic library and/or acoustic model, may flag the respective synthetic speech recording for removal.

Validation module 570 identifies each synthetic recording of the augmented synthetic positive data set and the augmented synthetic negative data set marked for removal and removes synthetic recordings from the augmented synthetic positive data set and the augmented synthetic negative data set, respectively, to generate a quality synthetic positive data set and a quality synthetic negative data set, respectively.

In some embodiments, the validation module 570 may provide the quality synthetic positive data set and quality synthetic negative data set to distribution manager 250. In some embodiments, the validation module 570 may store the quality synthetic positive data set and quality synthetic negative data set in a data store accessible by the distribution manager 250.

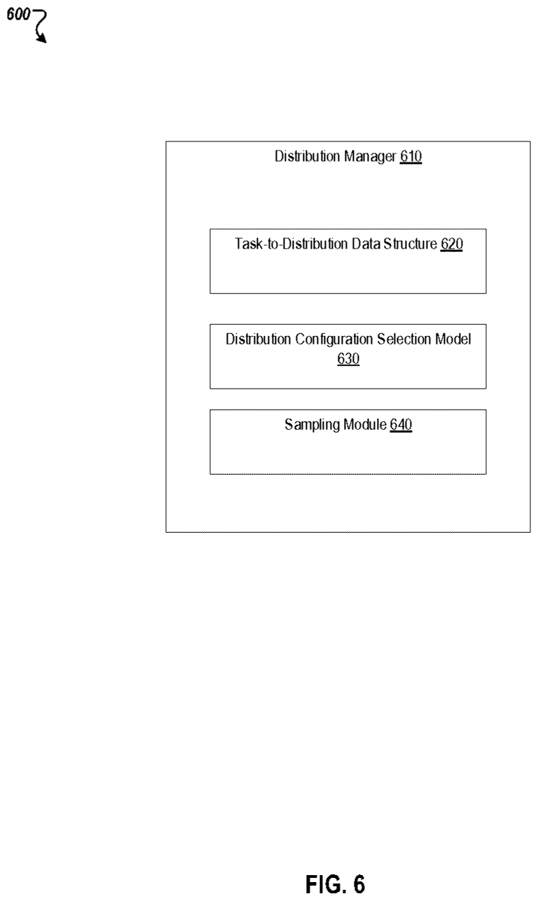

FIG. 6 illustrates an example distribution manager of the speech-based discriminative task platform, in accordance with implementations of the present disclosure. Distribution manager 610 (similar to distribution manager 250 of FIG. 2) includes a task-to-distribution data structure 620, a distribution configuration selection module 630, and a sampling module 640.

Task-to-distribution data structure 620 includes a plurality of entries in which each entry maps each speech-based discriminative task to a corresponding distribution configuration. Distribution configuration defines how sampling is to be applied to one or more data sets to achieve an appropriate ratio of types (e.g., positive to negative, synthetic to natural, male to female, native to non-native speakers, present augmentations, etc.). In some embodiments, the task-to-distribution data structure 620 may be apart and/or separate from the distribution manager 250, for example, stored in a data store (e.g., data store 130 of FIG. 1).

Distribution configuration selection module 630 receives a speech-based discriminative task and queries the task-to-distribution data structure 620 to identify a distribution configuration associated with the speech-based discriminative task. In some embodiments, the speech-based discriminative task may be the speech-based discriminative task inputted in the task filter by the user. Distribution configuration selection module 630 provides the distribution configuration associated with the speech-based discriminative task.

Sampling module 640 receives the distribution configuration associated with the speech-based discriminative task and a plurality of data sets. In some embodiments, the plurality of data sets may include the quality positive synthetic data set, the quality negative synthetic data set, the natural positive data set, and the negative natural data set. In some embodiments, the natural positive data set may not be available thus, the plurality of data sets may include the quality positive synthetic data set, the quality negative synthetic data set, and the negative natural data set.

Sampling module 640 samples (or selects) a predetermined amount of speech recordings from one or more of the plurality of data sets to comply with the appropriate ratios of types. Sampling module 640 stores all the sampled speech recordings in a balanced data set to be used for training a machine learning (ML) model. Accordingly, the balanced data set provides a balanced ratio between natural speech recordings and synthetic speech recordings. For example, the inclusion of synthetic speech recordings from the quality negative synthetic data sets assists in reducing the bias towards positive synthetic speech recordings. Similarly, for example, the inclusion of natural speech recordings from the natural positive data set and/or the natural negative data set assists in reducing the bias towards synthetic speech recordings. Sampling module 640 provides the balanced data set to the discriminative task process 260.

In some embodiments, the sampling module 640 may provide the balanced data set to the discriminative task process 260 (e.g., discriminative task process 260 of FIG. 2). In some embodiments, the sampling module 640 may store the balanced data set in a data store accessible by the discriminative task process 260.

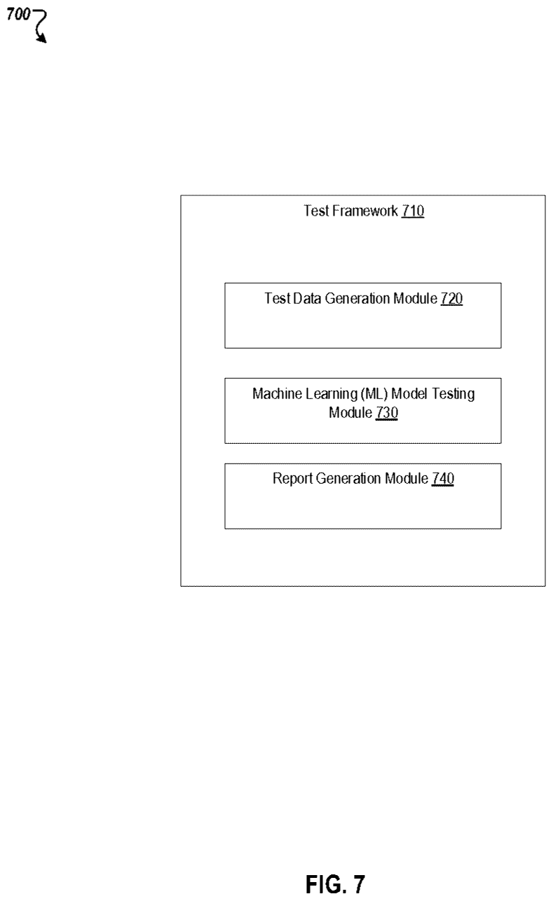

FIG. 7 illustrates an example test framework of the speech-based discriminative task platform, in accordance with implementations of the present disclosure. Test framework 710 (similar to test framework 270 of FIG. 2) includes a test data generation module 720, a machine learning (ML) model testing module 730, and a report generation module 740.

Test data generation module 142 receives a plurality of data sets to generate a plurality of test data. The plurality of data sets may include the synthetic positive data set, the synthetic negative data set, the augmented synthetic positive data set, the augmented synthetic negative data set, the quality synthetic positive data set, the quality synthetic negative data set, the natural positive data set, and the natural negative data set. In some embodiments, the natural positive data set may not be available. Thus, the plurality of data sets may include the synthetic positive data set, the synthetic negative data set, the augmented synthetic positive data set, the augmented synthetic negative data set, the quality synthetic positive data set, the quality synthetic negative data set, and the natural negative data set.

Test data generation module 142 selects one or more speech recordings from each data set of the plurality of data sets and labels the selected one or more speech recordings with the source of speech recordings as a data type. Each group of one or more speech recordings and labeled data type represents a test data of the plurality of test data. Test data generation module 142 provides the plurality of test data to the ML model testing module 730.

ML model testing module 730 receives the plurality of data sets and a trained ML model. The trained ML model refers to a machine learning model that was trained using the balanced data set to perform the speech-based discriminative task. As noted above, the balanced data set is generated by the distribution manager 250. ML model testing module 730 inputs each test data of the plurality of test data into the trained ML model to obtain a corresponding output. ML model testing module 730 labels the output with the same data type as the inputted test data. Accordingly, the ML model testing module 730 generates a plurality of outputs with data type labels. ML model testing module 730 provides the plurality of outputs with data type labels to the report generation module 740.

Report generation module 740 receives the plurality of outputs with data type labels and generates a results report organizing the plurality of outputs by the data type labels. The results report organized by data type labels provides visibility into whether any of the filters (e.g., task filter, augmentation analysis filter, and quality control filter) and/or distribution manager caused any biases in the trained ML.

Report generation module 740 may provide the results report to each of the filters (e.g., task filter, augmentation analysis filter, and quality control filter) and/or distribution manager to facilitate the improvement (through modification) of one or more filters of the filters and/or distribution manager for subsequent training of ML models for another speech-based discriminative task. In some embodiments, the report generation module 740 may store the results report in a data store accessible by the filters and/or distribution manager. Depending on the embodiment, the test framework may include a module that can directly modify the filters and/or distribution manager based on the results report rather than providing the filters and/or distribution manager the results report to perform their modifications.

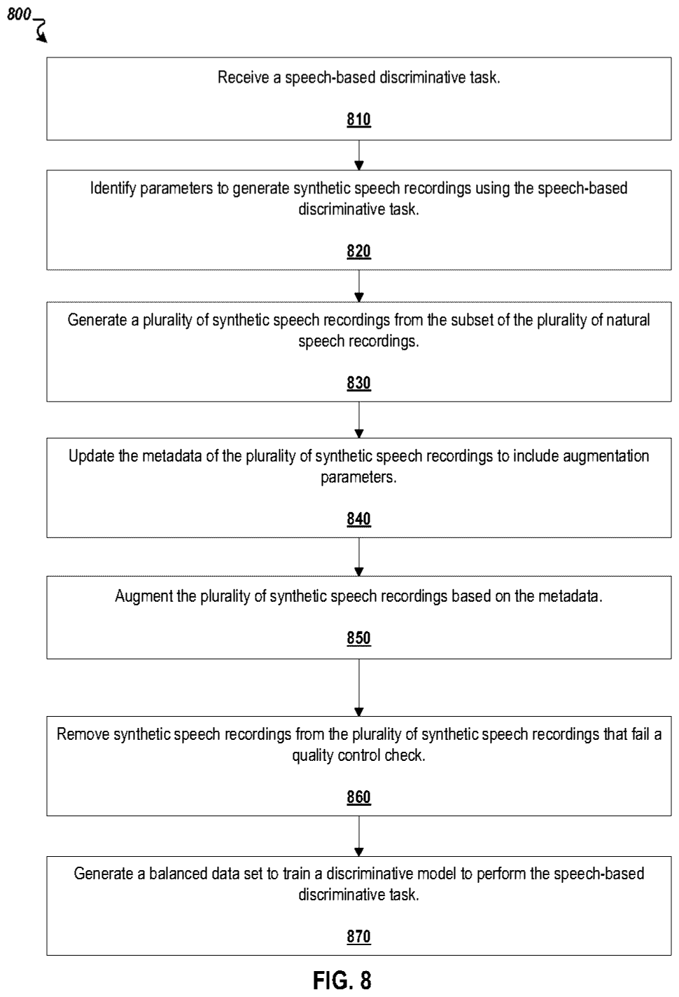

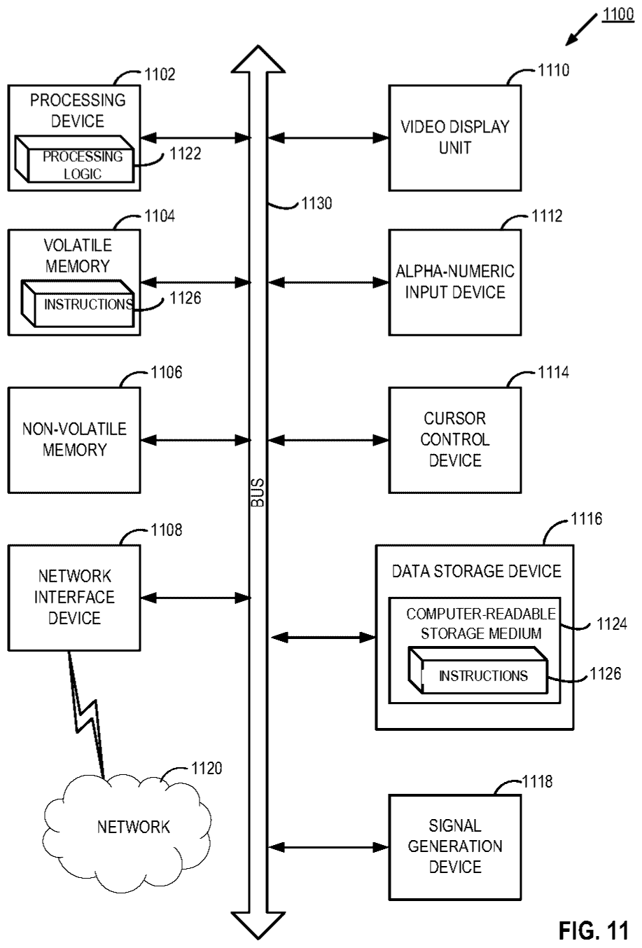

FIG. 8 depicts a flow diagram of an example method 800 for generating balanced data sets for speech-based discriminative tasks, in accordance with implementations of the present disclosure. Method 800 can be performed by processing logic that can include hardware (circuitry, dedicated logic, etc.), software (e.g., instructions run on a processing device), or a combination thereof. In one implementation, some, or all of the operations of method 800 can be performed by one or more components of system 1100 of FIG. 11. In some embodiments, some or all of the operations of method 800 can be performed by data generation module 142 of FIG. 1 and/or speech-based discriminative task platform 140 of FIG. 2, as described above.

At operation 810, the processing logic receives a speech-based discriminative task. A user or data engineer may input the speech-based discriminative task. The speech-based discriminative task may be keyword spotting, wake word detection, phoneme spotting, emotion detection, transcription, natural language processing (NLP), automatic speech recognition (ASR), etc.

At operation 820, the processing logic identifies parameters to generate synthetic speech recordings using the speech-based discriminative task. The parameters include a subset of a plurality of natural speech recordings and a set of speech characteristics. The processing logic identifies the set of speech characteristics of the parameters by querying, using the speech-based discriminative task. This task-to-speaker data structure maps each speech-based discriminative task to a set of speech characteristics. The subset of the plurality of natural speech recordings is also identified using the set of speech characteristics. The speech characteristics include prosody, duration, emotion, pitch, pace, emphasis, accents, and/or language.

At operation 830, the processing logic generates a plurality of synthetic speech recordings from the subset of the plurality of natural speech recordings. The processing logic provides a speech generation engine with the parameters. Using the parameters, the processing logic, causes the speech generation engine to generate the plurality of synthetic speech recordings. The plurality of synthetic speech recordings resembles speakers from the subset of the plurality of natural speech recordings. The speech generation engine may be a TTS engine.

At operation 840, the processing logic updates the metadata of the plurality of synthetic speech recordings to include augmentation parameters. The processing logic, using language science resources, identifies a difference between an expected speech recording and an actual speech recording for each of the plurality of synthetic speech recordings. The expected speech recording resembles what a natural speech recording would sound like. The processing logic determines a series of augmentation techniques and a specific ordering of the series of augmentation techniques, which minimizes (or eliminates) the difference between expected and actual speech recordings for each of the plurality of synthetic speech recordings so they match. The processing logic includes in the metadata, for each of the plurality of synthetic speech recordings, information indicating the series of augmentation techniques and the specific ordering of the series of augmentation techniques, which minimizes (or eliminates) the difference to be used as augmentation parameters.

At operation 850, the processing logic augments the plurality of synthetic speech recordings based on the metadata. The processing logic provides an augmentation engine with the plurality of synthetic speech recordings, which includes the metadata indicating the series of augmentation techniques and a specific ordering of the series of augmentation techniques. Using the metadata as augmentation parameters, the processing logic causes the augmentation engine to augment each of the plurality of synthetic speech recordings. The plurality of synthetic speech recordings would be augmented to resemble natural speech.

At operation 860, the processing logic removes synthetic speech recordings from the plurality of synthetic speech recordings that fail a quality control check. The processing logic performs annotation and alignment between the speech recordings and text associated with the speech recordings for each of the plurality of synthetic speech recordings. The processing logic removes any synthetic speech recordings that failed annotation and alignment from the plurality of synthetic speech recordings. The processing logic may further analyze each synthetic speech recording of the plurality of synthetic speech recordings in view of the language science resources to identify any low-quality synthetic speech recordings. Thus, the processing logic removes the synthetic speech recordings with low quality from the plurality of synthetic speech recordings.

At operation 870, the processing logic generates a balanced data set to train a discriminative model to perform the speech-based discriminative task. The processing logic receives a subset of the plurality of natural speech recordings and the plurality of synthetic speech recordings to generate the balanced data set. In particular, the processing logic queries, using the speech-based discriminative task, a task-to-distribution data structure that maps each speech-based discriminative task to a distribution configuration. Distribution configuration defines how sampling is to be applied to the subset of the plurality of natural speech recordings and the plurality of synthetic speech recordings to achieve an appropriate ratio of positive to negative, synthetic to natural, male to female, native to non-native speakers, present augmentations, etc.

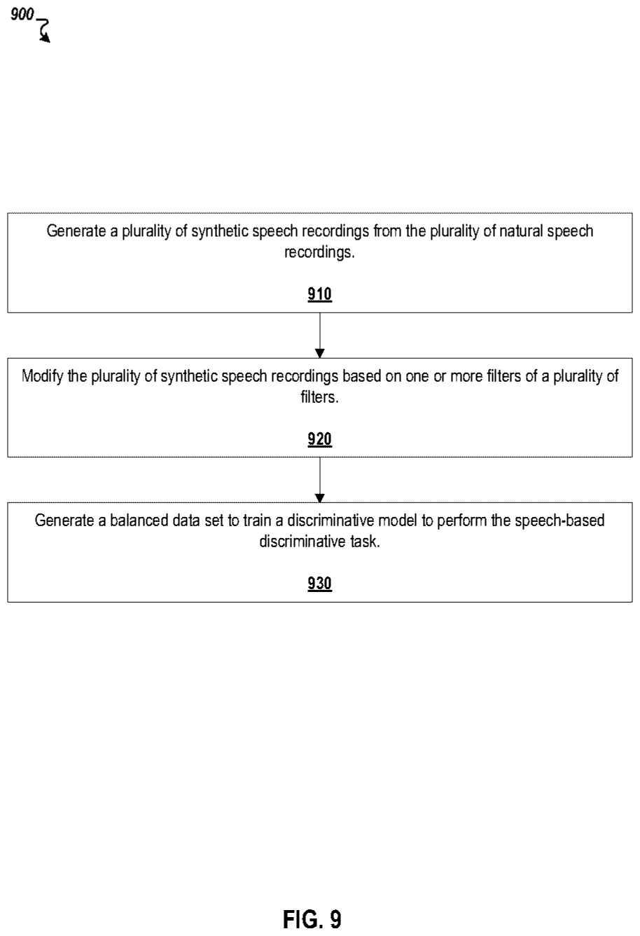

FIG. 9 depicts a flow diagram of an example method 900 for generating balanced data sets for speech-based discriminative tasks in accordance with implementations of the present disclosure. Method 900 can be performed by processing logic that can include hardware (circuitry, dedicated logic, etc.), software (e.g., instructions run on a processing device), or a combination thereof. In one implementation, some, or all of the operations of method 900 can be performed by one or more components of system 1100 of FIG. 11. In some embodiments, some or all of the operations of method 900 can be performed by data generation module 142 of FIG. 1 and/or speech-based discriminative task platform 140 of FIG. 2, as described above.

At operation 910, the processing logic generates a plurality of synthetic speech recordings from the plurality of natural speech recordings. In particular, the processing logic receives a speech-based discriminative task used to query a task-to-speaker data structure that maps each speech-based discriminative task to a set of speech characteristics. A subset of the plurality of natural speech recordings is identified using the set of speech characteristics. The set of speech characteristics and a subset of the plurality of natural speech recordings obtained using the set of speech characteristics are provided to a speech generation engine. The speech generation engine generates the plurality of synthetic speech recordings based on the provided inputs.

At operation 920, the processing logic modifies the plurality of synthetic speech recordings based on one or more filters of a plurality of filters.

In some embodiments, the processing logic updates the metadata of the plurality of synthetic speech recordings to include augmentation parameters. Using language science resources, the processing logic identifies a difference between an expected speech recording and an actual speech recording for each of the plurality of synthetic speech recordings. The processing logic includes in the metadata, for each of the plurality of synthetic speech recordings, information indicating a series of augmentation techniques and the specific ordering of the series of augmentation techniques, which minimizes (or eliminates) the difference between an expected and an actual speech recording for each of the plurality of synthetic speech recordings, so they match.

In some embodiments, the processing logic performs annotation and alignment between the speech recordings and text associated with the speech recordings for each of the plurality of synthetic speech recordings. The processing logic removes any synthetic speech recordings that failed annotation and alignment from the plurality of synthetic speech recordings. In view of the language science resources, the processing logic removes synthetic speech recordings with low quality from the plurality of synthetic speech recordings.

At operation 930, the processing logic generates a balanced data set to train a discriminative model to perform the speech-based discriminative task. In particular, the processing logic queries, using the speech-based discriminative task, a task-to-distribution data structure that maps each speech-based discriminative task to a distribution configuration. Distribution configuration defines how sampling is to be applied to the subset of the plurality of natural speech recordings and the plurality of synthetic speech recordings to achieve an appropriate ratio of positive to negative, synthetic to natural, male to female, native to non-native speakers, present augmentations, etc.

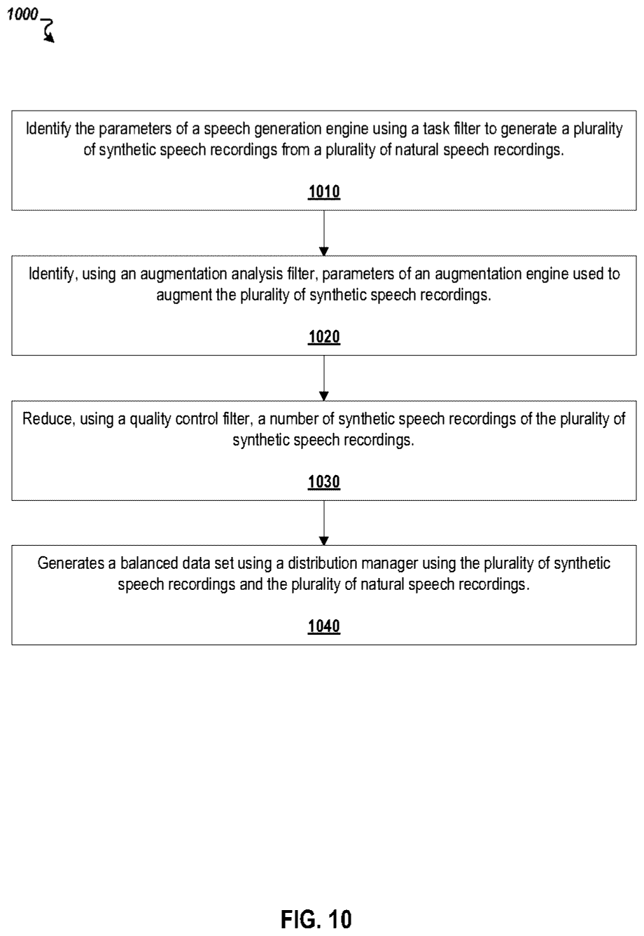

FIG. 10 depicts a flow diagram of an example method 1000 for generating balanced data sets for speech-based discriminative tasks, in accordance with implementations of the present disclosure. Method 1000 can be performed by processing logic that can include hardware (circuitry, dedicated logic, etc.), software (e.g., instructions run on a processing device), or a combination thereof. In one implementation, some, or all of the operations of method 1000 can be performed by one or more components of system 1100 of FIG. 11. In some embodiments, some or all of the operations of method 1000 can be performed by data generation module 142 of FIG. 1 and/or speech-based discriminative task platform 140 of FIG. 2, as described above.

At operation 1010, the processing logic identifies the parameters of a speech generation engine using a task filter to generate a plurality of synthetic speech recordings from a plurality of natural speech recordings. Parameters of the speech generation engine include a natural data set and a set of speech characteristics. The processing logic causes the task filter to obtain, using a received speech-based discriminative task, the set of speech characteristics from a task-to-speaker data structure that maps each speech-based discriminative task to a set of speech characteristics. The processing logic causes the task filter to query a natural speech database to identify one or more natural speech recordings of the natural speech database in view of the set of speech characteristics.

At operation 1020, the processing logic identifies, using an augmentation analysis filter, parameters of an augmentation engine used to augment the plurality of synthetic speech recordings. Parameters of the augmentation engine are a specific ordering of a series of augmentation techniques. The processing logic causes the augmentation analysis filter to identify differences between an expected speech recording and an actual speech recording for each of the plurality of synthetic speech recordings to determine the parameters of the augmentation engine that minimizes (or eliminates) the difference. The processing logic causes the augmentation analysis filter to update the metadata for each of the plurality of synthetic speech recordings with their corresponding parameters of the augmentation engine.

At operation 1030, the processing logic reduces, using a quality control filter, a number of synthetic speech recordings of the plurality of synthetic speech recordings. The processing logic causes the quality control filter to perform annotation and alignment between the speech recordings and text associated with the speech recordings for each of the plurality of synthetic speech recordings. The processing logic causes the quality control filter to remove from the plurality of synthetic speech recordings any synthetic speech recordings that failed annotation and alignment.

At operation 1040, the processing logic generates a balanced data set using a distribution manager using the plurality of synthetic speech recordings and the plurality of natural speech recordings. The processing logic causes the distribution manager to query, using the speech-based discriminative task, a task-to-distribution data structure for a distribution configuration associated with the speech-based discriminative task. The processing logic causes the distribution manager to sample from the plurality of synthetic speech recordings and the plurality of natural speech recordings that achieve an appropriate ratio of positive to negative, synthetic to natural, male to female, native to non-native speakers, present augmentations, etc.

FIG. 11 is a block diagram illustrating an exemplary computer system 1100, in accordance with implementations of the present disclosure. The computer system 1100 can correspond to microcontroller 120 and/or data generation module 142 described with respect to FIG. 1 and/or speech-based discriminative task platform 140 described with respect to FIG. 2. Computer system 1100 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processing device (processor) 1102, a main memory 1104 (e.g., read-only memory (ROM), flash memory, dynamic random access memory (DRAM) such as synchronous DRAM (SDRAM), double data rate (DDR SDRAM), or DRAM (RDRAM), etc.), a static memory 1106 (e.g., flash memory, static random access memory (SRAM), etc.), and a data storage device 1118, which communicate with each other via a bus 1150.

Processor (processing device) 1102 represents one or more general-purpose processing devices such as a microprocessor, central processing unit, or the like. More particularly, the processor 1102 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1102 can also be one or more special-purpose processing devices, such as an application-specific integrated circuit (ASIC), a field programmable gate array (FPGA), a digital signal processor (DSP), a network processor, or the like. The processor 1102 is configured to execute instructions 1126 (e.g., when executed provides groupwise encoding) for performing the operations discussed herein.

The computer system 1100 can further include a network interface device 1108. The computer system 1100 also can include a video display unit 1110 (e.g., a liquid crystal display (LCD) or a cathode ray tube (CRT)), an input device 1112 (e.g., a keyboard, an alphanumeric keyboard, a motion sensing input device, touch screen), a cursor control device 1114 (e.g., a mouse), and a signal generation device 1120 (e.g., a speaker).

The data storage device 1118 can include a non-transitory machine-readable storage medium 1124 (also computer-readable storage medium) on which is stored one or more sets of instructions 1126 (e.g., when executed provides groupwise encoding) embodying any one or more of the methodologies or functions described herein. The instructions can also reside, completely or at least partially, within the main memory 1104 and/or within the processor 1102 during execution thereof by the computer system 1100, the main memory 1104 and the processor 1102 also constituting machine-readable storage media. The instructions can further be transmitted or received over a network 1130 via the network interface device 1108.

In one implementation, the instructions 1126 include instructions for groupwise encoding. While the computer-readable storage medium 1124 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that causes the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution, and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

1. A method comprising:
receiving a plurality of natural speech recordings to train a discriminative model to perform a speech-based discriminative task;
identifying, based on the speech-based discriminative task, a set of speech characteristics;
receiving, based on the set of speech characteristics and the plurality of natural speech recordings, a synthetic speech data set;
modifying, based on language science resources, metadata associated with each synthetic speech recording of the synthetic speech data set to obtain a modified synthetic speech data set;
determining, based on the modified synthetic speech data set, an augmented synthetic speech data set;
identifying, based on the augmented synthetic speech data set, a subset of the augmented synthetic speech data set in view of language science resources; and
generating, based on the subset of the augmented synthetic speech data set and a subset of the plurality of natural speech recordings, a balanced data set to train a plurality of synthetic speech recordings.

2. The method of claim 1, wherein the speech-based discriminative task is one of: keyword spotting, wake word detection, phoneme spotting, emotion detection, transcription, natural language processing (NLP), or automatic speech recognition (ASR).

3. The method of claim 1, wherein the set of speech characteristics includes at least one of: prosody, duration, emotion, pitch, pace, emphasis, accents, or language.

4. The method of claim 1, wherein the language science resources include at least one of: a phonemes library, an acoustic model, or a linguistic library.

5. The method of claim 1, wherein receiving, based on the set of speech characteristics and the plurality of natural speech recordings, the synthetic speech data set comprises:
identifying, based on the set of speech characteristics, a subset of the plurality of natural speech recordings;
configuring a speech generation engine in view of the set of speech characteristics; and
inputting, into the speech generation engine, the subset of the plurality of natural speech recordings to generate the synthetic speech data set.

6. The method of claim 1, wherein modifying, based on language science resources, metadata associated with each synthetic speech recording of the synthetic speech data set comprises:
for each synthetic speech recording of the synthetic speech data set, identifying an expected speech characteristic for a respective synthetic speech recording;
generating, based on language science resources, an expected speech recording for the respective synthetic speech recording;
comparing the respective synthetic speech recording to the expected speech recording; and
updating metadata of the respective synthetic speech recording to include information used to augment the respective synthetic speech recording to match the expected speech recording.

7. The method of claim 1, determining, based on the modified synthetic speech data set, an augmented synthetic speech data set comprises:
for each synthetic speech recording of the synthetic speech data set, identifying information from the metadata for modifying a respective synthetic speech recording; and
modifying, based on the information, one or more characteristics of the respective synthetic speech recording to generate a corresponding augmented synthetic speech recording of the augmented synthetic speech data set.

8. The method of claim 1, wherein generating, based on the subset of the augmented synthetic speech data set and the subset of the plurality of natural speech recordings, the balanced data set to train the discriminative model comprises:
determining, based on the speech-based discriminative task, a distribution configuration;
generating, based on the distribution configuration, a first subset of the balanced data set, wherein the first subset of the balanced data set comprises one or more augmented synthetic speech recordings of the subset of the augmented synthetic speech data set;
generating, based on the distribution configuration, a second subset of the balanced data set, wherein the second subset of the balanced data set comprises one or more natural speech recordings of the subset of the plurality of natural speech recordings; and
combining the first subset of the balanced data set and the second subset of the balanced data set to generate the balanced data set.

9. A system comprising:
a processing device to perform operations comprising:
generating, based on a plurality of natural speech recordings, a synthetic speech data set;
modifying, based on language science resources, the synthetic speech data set; and
generating, based on the modified synthetic speech data set and the plurality of natural speech recordings, a balanced data set for training a discriminative model to perform a speech-based discriminative task.

10. The system of claim 9, wherein generating, based on the plurality of natural speech recordings, the synthetic speech data set comprises:
identifying, based on the speech-based discriminative task, a set of speech characteristics;
selecting, based on the set of speech characteristics, a subset of the plurality of natural speech recordings;
configuring a speech generation engine in view of the set of speech characteristics; and
generating, using the speech generation engine, the synthetic speech data set based on the subset of the plurality of natural speech recordings.

11. The system of claim 10, wherein the set of speech characteristics includes at least one of:
prosody, duration, emotion, pitch, pace, emphasis, accents, or language.

12. The system of claim 10, wherein the speech-based discriminative task is one of: keyword spotting, wake word detection, phoneme spotting, emotion detection, transcription, natural language processing (NLP), or automatic speech recognition (ASR).

13. The system of claim 9, wherein the language science resources include at least one of: a phonemes library, an acoustic model, or a linguistic library.

14. The system of claim 9, wherein modifying, based on language science resources, the synthetic speech data set comprises:
for each synthetic speech recording of the synthetic speech data set, identifying an expected speech characteristic for a respective synthetic speech recording;
generating, based on language science resources, an expected speech recording for the respective synthetic speech recording;
comparing the respective synthetic speech recording to the expected speech recording; and
updating metadata of the respective synthetic speech recording to include information used to augment the respective synthetic speech recording to match the expected speech recording.

15. The system of claim 9, wherein modifying, based on language science resources, the synthetic speech data set comprises:
identifying, for each synthetic speech recording of the synthetic speech data set, phonemes associated with a respective synthetic speech recording;
determining phonemes associated with text of the respective synthetic speech recording;
aligning the phonemes associated with the respective synthetic speech recording with the phonemes associated with the text of the respective synthetic speech recording; and
responsive to failing to align the phonemes associated with the respective synthetic speech with the phonemes associated with the text of the respective synthetic speech recording, removing the respective synthetic speech recording from the synthetic speech data set.

16. The system of claim 9, wherein generating, based on the modified synthetic speech data set, the balanced data set from the discriminative model comprises:
determining, based on the speech-based discriminative task, a distribution configuration;
generating, based on the distribution configuration, a first subset of the balanced data set, wherein the first subset of the balanced data set comprises one or more synthetic speech recordings of the modified synthetic speech data set;
generating, based on the distribution configuration, a second subset of the balanced data set, wherein the second subset of the balanced data set comprises one or more natural speech recordings of the plurality of natural speech recordings; and
combining the first subset of the balanced data set and the balanced data set to generate the balanced data set.

17. A non-transitory computer-readable storage medium comprising instructions that, when executed by a processing device, cause the processing device to perform operations comprising:
generating, based on a speech-based discriminative task, a set of speech characteristics to generate a synthetic speech data set based on a plurality of natural speech recordings;
for each synthetic speech recording of the synthetic speech data set, updating metadata of a respective synthetic speech recording to include information used to augment the respective synthetic speech recording to match an expected speech recording for the respective synthetic speech;
selecting, based on language science resources, a subset of the synthetic speech data set; and
generating, based on the subset, a balanced data set to train the discriminative model.

18. The non-transitory computer-readable storage medium of claim 17, wherein the processing device is to perform operations further comprising:
selecting, based on the set of speech characteristics, a subset of a plurality of natural speech recordings;
configuring a speech generation engine in view of the set of speech characteristics; and
generating, using the speech generation engine, the synthetic speech data set based on the subset.

19. The non-transitory computer-readable storage medium of claim 17, wherein updating metadata of the respective synthetic speech recording to include information used to augment the respective synthetic speech recording to match the expected speech recording for the respective synthetic speech comprises:
identifying an expected speech characteristic for the respective synthetic speech recording;
generating, based on language science resources, the expected speech recording for the respective synthetic speech recording;
comparing the respective synthetic speech recording to the expected speech recording; and
determining, based on the comparison, the information used to update the metadata of the respective synthetic speech recording.

20. The non-transitory computer-readable storage medium of claim 17, wherein selecting, based on language science resources, the subset of the synthetic speech data set comprises:
identifying, for each synthetic speech recording of the synthetic speech data set, phonemes associated with a respective synthetic speech recording;
determining phonemes associated with text of the respective synthetic speech recording;
aligning the phonemes associated with the respective synthetic speech recording with the phonemes associated with the text of the respective synthetic speech recording; and
responsive to failing to align the phonemes associated with the respective synthetic speech with the phonemes associated with the text of the respective synthetic speech recording, removing the respective synthetic speech recording from the synthetic speech data set to generate the subset.
